(19) United States
(12) Patent Application Publication
(10) Pub. No.: US 2005/0046097 A1
(43) Pub. Date: Mar. 3, 2005

(54) Pneumatic suspension system

(76) Inventor: Ju-Ho Kim, Gyeonggi-do (KR)

Correspondence Address: MORGAN, LEWIS & BOCKIUS, LLP., 2 PALO ALTO SQUARE, 3000 EL CAMINO REAL, PALO ALTO, CA, 94306, US

(21) Appl. No.: 10/749,221

(22) Filed: Dec. 30, 2003

(30) Foreign Application Priority Data
Sep. 3, 2003 (KR) 10-2003-0061466

(51) Int. Cl. F16F 9/00

(52) U.S. Cl. 267/113

(57) ABSTRACT

A pneumatic suspension system, whereby an amount of air infused into an inner upper side of a cylinder is controlled via an air nozzle, and air flow circulating between an inner upper side and an inner lower side of the cylinder is controlled by opening and closing of a solenoid valve to adjust an air pressure inside the cylinder, thereby enabling a smooth damper function. A main spring is installed inside the cylinder to effectively utilize an external space of the cylinder.

### CROSS-REFERENCE TO RELATED APPLICATIONS

This application claims priority of Korean Application No. 10-2003-0061466, filed on Sep. 3, 2003, the disclosure of which is incorporated fully herein by reference.

### FIELD OF THE INVENTION

The present invention relates to a pneumatic suspension system.

### BACKGROUND OF THE INVENTION

A suspension system of a vehicle is comprised of springs for absorbing shock from road beds, shock absorbers for improving the ride of a vehicle by restricting free vibration of the springs, arms or links for controlling the operation of wheels and the like.

Shock absorbers function as dampers for absorbing intrinsic vibration generated by shock received from the springs while a vehicle is in motion to quickly reduce the vibration and enhance the ride.

### SUMMARY OF THE INVENTION

Embodiments of the present invention provide a pneumatic suspension system adapted to allow shock absorbers using air as operating fluid to actively control air pressure, thereby greatly improving the ride of a vehicle. Preferably, the shock absorbers are configured to install springs inside a cylinder to effectively use external space.

In accordance with a preferred embodiment of the present invention, pneumatic suspension system comprises a cylinder, a piston reciprocating inside the cylinder in response to vehicle vibration, and a piston rod connected to the piston to protrude outside of the cylinder. The pneumatic suspension system further comprises a main spring mounted inside the cylinder for absorbing shock; detecting means for detecting a position and motion of the piston; an air nozzle connected to an actuator for supplying air into the cylinder in response to the position and motion of the piston; an air passage for connecting an upper side and a lower side of the cylinder so that air in the upper space and lower space can be circulated; and a solenoid valve for opening and closing the air passage.

The detecting means preferably includes at a circumferential surface thereof a magnetic belt attached in the longitudinal direction thereof and a sensor for sensing the position of the magnetic belt.

The cylinder is preferably mounted at an inner upper side and an inner lower side thereof with shock absorbing members for absorbing shock generated by movement of the piston. The shock absorbing members are preferably fixed to auxiliary springs, each closely abutted to an inner upper surface and an inner lower surface of the cylinder.

The air passage is preferably formed at a peripheral surface of the cylinder in the longitudinal direction thereof, or formed at an inner circumferential surface of the cylinder in the longitudinal direction thereof, or formed at an inner wall surface of the cylinder in the longitudinal direction thereof.

### BRIEF DESCRIPTION OF THE DRAWINGS

For a better understanding of the nature and objects of the present invention, reference should be made to the following detailed description with the accompanying drawings, in which:

FIG. 1 is a cross-sectional view illustrating a pneumatic suspension system according to an embodiment of the present invention;

FIG. 2 is a perspective view of an air passage of FIG. 1;

FIG. 3 is a cross-sectional view illustrating air flow when a piston rises according to an embodiment of the present invention;

FIG. 4 is a cross-sectional view illustrating air flow when a piston descends according to an embodiment of the present invention;

FIG. 5 is a cross-sectional view illustrating air infusing through an air nozzle when a piston is suddenly raised according to an embodiment of the present invention;

FIG. 6 is a block diagram of an air flow control system according to an embodiment of the present invention; and

FIG. 7 is a cross-sectional view of an air passage formed at an inner circumferential surface of a cylinder according to another embodiment of the present invention.

### DETAILED DESCRIPTION OF THE PREFERRED EMBODIMENT

The preferred embodiment of the present invention will now be described in detail with reference to the annexed drawings.

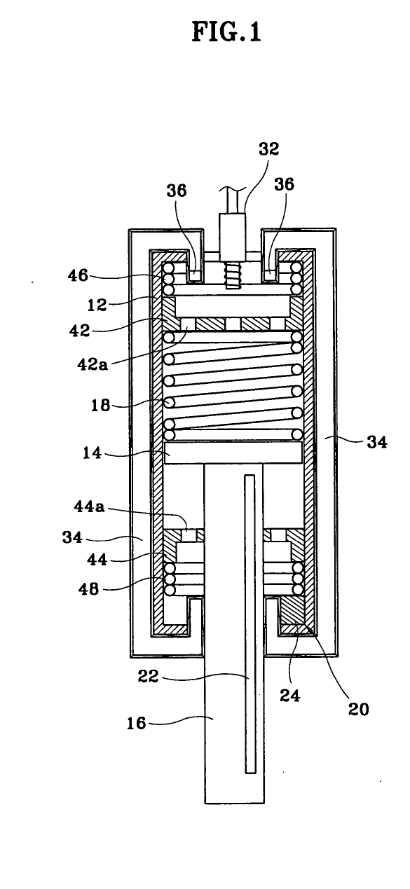

As shown in FIG. 1, a cylinder 12 is coupled to a piston 14 reciprocatively moving in response to vehicle vibration, and the piston 14 is fixed to a piston rod 16 externally protruding at one side of the cylinder.

The cylinder 12 is further mounted therein (at an upper space of the piston) with a main spring 18 for absorbing shock, detecting means 20 equipped with a magnetic belt 22 and a sensor 24 for detecting a position and motion of the piston 14.

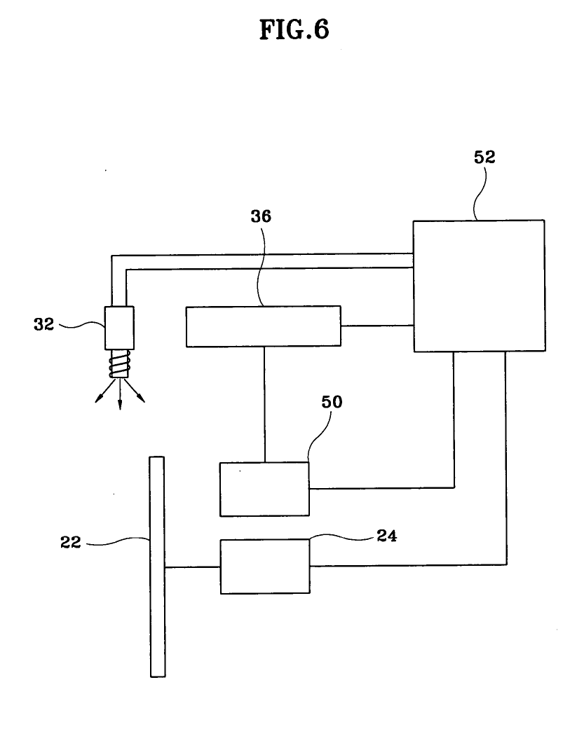

The cylinder 12 is still further mounted at an upper end thereof with an air nozzle 32 connected to an actuator (see FIG. 6) for supplying air into the cylinder 12 (at an upper space of the piston 14) in response to the position and motion of the piston 14, and is also installed with an air passage 34 for connecting an upper end to a lower end of the cylinder 12 so that air in the upper space and lower space of the piston 14 can be circulated.

A solenoid valve 36 is coupled to an upper end of the cylinder 12 for opening and closing the air passage 34.

The cylinder 12 is disposed at an inner upper side and an inner lower side thereof with shock absorbers 42 and 44 for absorbing shock generated in response to the movement of the piston 14. The shock absorbers 42 and 44 are fixed to auxiliary springs 46 and 48, each abutted to an inner upper surface and an inner lower surface of the cylinder 12.

The magnetic belt 22 of the detecting means 20 is attached to a circumferential surface of the piston rod 16 in the longitudinal direction thereof, and the sensor 24 is coupled to an inner lower side of the cylinder for detecting the position of the magnetic belt 22.

The air nozzle 32, as shown in FIG. 6, is connected to an actuator 52 controlled by an Electronic Control Unit (ECU.50). ECU 50 may comprise a processor and associated hardware and/or software as may be selected and programmed by a person of ordinary skill in the art based on the teachings of the present invention.

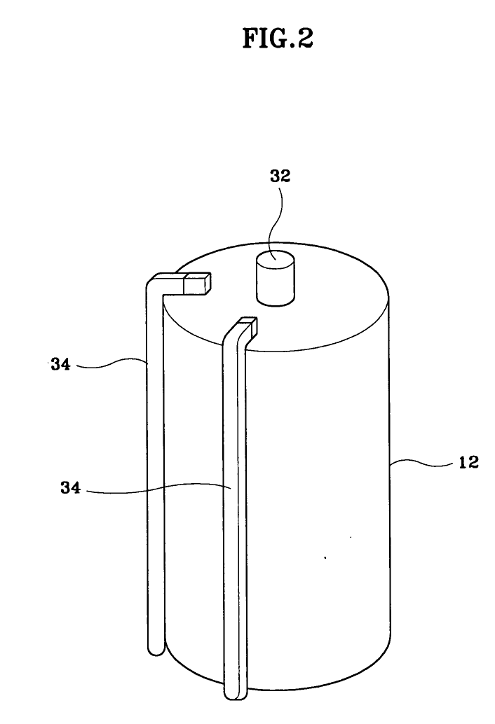

As depicted in FIG. 2, the air passage 34 is formed at a circumferential surface of the cylinder in the longitudinal direction thereof, and the upper end and lower end of the air passage 34 communicates with the interior of the cylinder 12 via the upper surface and lower surface of the cylinder 12. Furthermore, the upper end of the air passage 34 is mounted with the solenoid valve 36 controlled by the ECU 50.

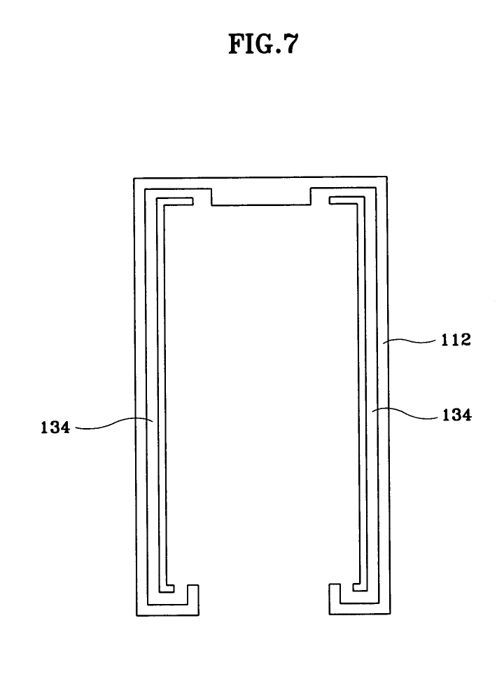

As shown in FIG. 7, an air passage 134 is preferably formed at an inner circumferential surface of a cylinder 112 according to another embodiment of the present invention, and an air flow is preferably formed at an inner wall surface of the cylinder in the longitudinal direction thereof.

The shock absorbers 42 and 44 are made of cylindrical rubber, and is centrally formed with a plurality of air holes 42a and 44a for air ventilation.

As shown in the FIG. 6, the ECU 50 sends a driving signal to the solenoid valve 36 and the actuator 52 in response to an input signal of the sensor 24 to actuate the solenoid valve 36 and the actuator 52 such that air can be introduced into the cylinder 12 via the air nozzle 32, or the air passage 34 can be opened and closed.

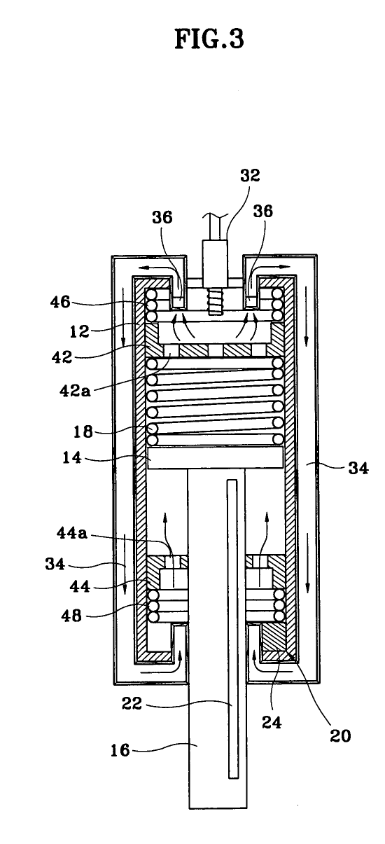

FIGS. 3 to 5 illustrate in more detail the air flow in response to the movement of the piston 14. As shown in FIG. 3, when the piston 14 is raised, the main spring 18 absorbs shock and air in the upper space of the piston 14 slowly moves to the lower space of the piston 14 via the air passage 34 to reduce the shock against the sudden pressure increase applied to the piston 14.

Furthermore, when the piston 14 is raised in excess of a prescribed level, the ECU 50 detects the position of the magnetic belt 22 by way of the sensor 24 to output a control signal, and the actuator 52 sends air to the space in the upper side of the cylinder 12 via the air nozzle 32 in response to the control signal.

The ECU 50 calculates air pressure and air supply time appropriate for maximally and smoothly stopping the ascending operation of the piston 14 to control the actuator 52 such that the piston 14 smoothly stops the ascending operation by the air supplied to the upper space of the cylinder 12 via the actuator 52.

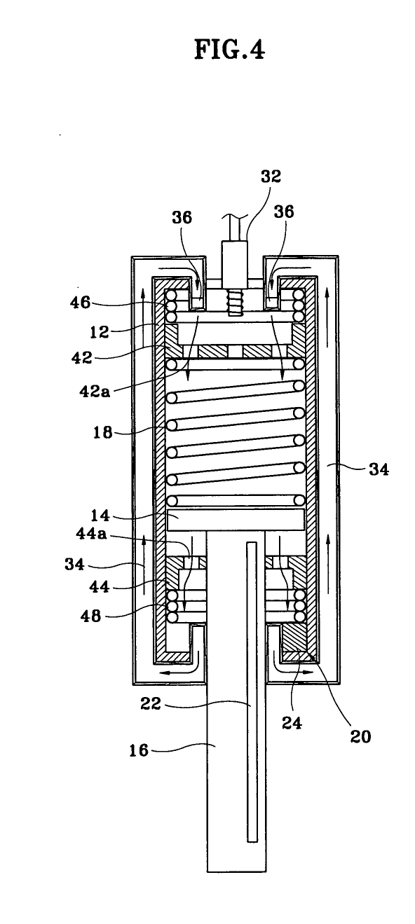

As illustrated in FIG. 4, when the piston 14 descends, the air is controlled not to be introduced via the air nozzle 32, and air in the lower space of the piston 14 is slowly moved to the upper space of the piston 14 via the air passage 34.

As a result, the upper space of the piston 14 is lowered in pressure thereof in response to the descending piston 14 to delay the descending operation of the piston 14, and the lower space of the piston 14 is raised in pressure thereof in response to the descending piston 14 to delay the descending operation of the piston 14 such that the descending force of the piston 14 is quickly reduced to swiftly stop the vertical vibration of the piston 14.

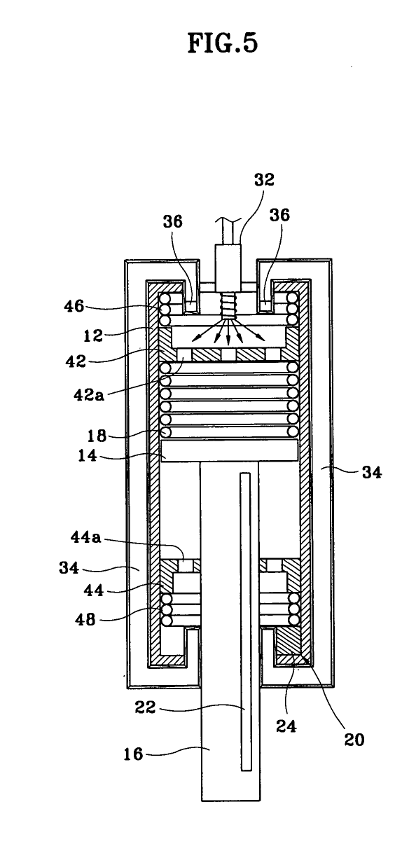

As shown in FIG. 5, when pressure is applied to suddenly raise the piston 14, a sensing signal from the sensor 24 for detecting position of the magnetic belt 22 is inputted to the ECU 50. The solenoid valve 36 and the actuator 52 are actuated by a control signal generated from the ECU 50 to close the solenoid valve 36, whereby the air is quickly introduced into the upper space of the cylinder 12 via the air nozzle 32. This introduction of air increases the pressure to prevent the piston 14 from transmitting shock directly to the upper side of the cylinder 12.

As apparent from the foregoing, there is an advantage in the pneumatic suspension system thus described according to the embodiments of the present invention in that the air infuse into the inner upper side of a cylinder is controlled via an air nozzle, and air flow circulating between the inner upper side and inner lower side of the cylinder is controlled by opening and closing of a solenoid valve to adjust the air pressure inside the cylinder, thereby enabling to embody a smooth damper function.

There is another advantage in that a main spring is installed inside a cylinder to effectively utilize an external space of the cylinder.

1. A pneumatic suspension system comprising:
a cylinder;
a piston disposed inside said cylinder for reciprocation in response to vehicle vibration;
a piston rod connected to said piston to protrude outside of said cylinder;
a main spring mounted inside said cylinder for absorbing shock;
detecting means for detecting a position and motion of said piston;
an air nozzle connected to an actuator for supplying air into said cylinder in response to the position and motion of said piston;
an air passage for connecting an upper side and lower side of said cylinder so that air in the upper space and lower space can be circulated; and
a solenoid valve for opening and closing said air passage.

2. The system as defined in claim 1, wherein said detecting means comprises:
a magnetic belt attached to the piston rod along a longitudinal direction thereof; and
a sensor for sensing the position of the piston via said magnetic belt.

3. The system as defined in claim 1, wherein said cylinder is mounted at an inner upper side and an inner lower side thereof with shock absorbing members for absorbing shock generated by movement of said piston.

4. The system as defined in claim 3, wherein said shock absorbing members are fixed to auxiliary springs, each closely abutted to the inner upper surface and inner lower surface of said cylinder.
